(19) United States
(12) Patent Application Publication
(10) Pub. No.: US 2024/0307254 A1
(43) Pub. Date: Sep. 19, 2024

(54) A massager with a retractable massage head

(71) Applicant: SHENZHEN FORREST HEALTH TECHNOLOGY CO., LTD., Shenzhen, Guangdong (CN)

(72) Inventors: Jianzhong Pan, Shenzhen, Guangdong (CN); Yongchao Zhao, Shenzhen, Guangdong (CN)

(21) Appl. No.: 18/576,581

(22) PCT Filed: Feb. 9, 2023
(86) PCT No.: PCT/CN2023/075120

§ 371 Date: Jan. 4, 2024

(30) Foreign Application Priority Data
May 10, 2022 (CN) 202210507900.X

(51) Int. Cl. A61H 15/00

(52) U.S. Cl. CPC A61H 15/0078; A61H 2201/0103; A61H 2201/1611

(57) ABSTRACT

The present invention discloses a massager with a retractable massage head, comprising a housing, in which there is a driving assembly. On top of the housing, there is the massage head connected with the driving assembly in a transmission way; between the housing and the massage head, there are jacking support, jacking part, and jacking bracket. The jacking bracket is connected with the top of the housing in a fixed way, the bottom of the massage head is connected with a transmission shaft in a fixed way, the end of the transmission shaft away from the massage head passes through the jacking support, the supporting part, the supporting bracket, and the top of the housing and is connected with the driving assembly, and there is a reset spring at the end of the transmission shaft connected with the driving assembly. Based on the aforesaid design, it is possible to extend the massage head by providing the jacking part, so as to meet the usage requirements of different people. Furthermore, by providing the sliding transmission shaft and the reset spring, the transmission shaft will be extended and retracted synchronously when the massage head is extended and retracted, so as to achieve the complete retraction of the massage head as a whole without affecting the other ways to use the massager, and improve the usage experience of the user.

### FIELD OF INVENTION

The present invention relates to the field of nursing equipment, in particular to a massager with a retractable massage head.

### BACKGROUND OF INVENTION

With the growth in the living standard, the pace of life is further accelerated; for those who have to work at their desk for a long time, it is easy to cause cervical spine disease because the cervical spine remains in a state for a long time. The neck care devices are very helpful in prevention of cervical spine disease because they are used to relax the neck muscles.

For the existing neck massagers with retractable massage head available in the market, the rolling massage head can only be retracted, but the guide pillars supporting the massage head to slide cannot be retracted but are left outside, so it is impossible to retract the massage head as a whole, resulting in the inconvenience to other usages of the massager. For example, if the massager is used as the neck pillow, the usage experience of the massager will be affected due to the protrusion of the guide pillars.

Therefore, it is urgent to design a massager with a retractable massage head to overcome the shortcomings in the prior art.

### DESCRIPTION OF UTILITY MODEL

The technical scheme adopted by the present utility model to achieve the above technical purpose is: A massager with a retractable massager head comprises a massager body adaptable to the human neck and at least two massage devices, the said massage devices are provided on the side of the said massage body adjacent to the human body, and are characterized by that each said massage device comprises a housing, in which there is a driving assembly. On top of the said housing, there is the massage head connected with the said driving assembly in a transmission way; between the said housing and the said massage head, there are jacking support, jacking part, and jacking bracket from top to bottom. The said jacking bracket is connected with the top of the said housing in a fixed way, the said jacking part is located on the said jacking bracket, the said jacking support is butted with the bottom of the said massage head, the bottom of the said massage head is connected with a transmission shaft in a fixed way, the end of the said transmission shaft away from the said massage head passes through the said jacking support, the said supporting part, the said supporting bracket, and the top of the said housing and is connected with the said driving assembly, and there is a reset spring at the end of the said transmission shaft connected with the said driving assembly.

In a preferred embodiment, the said driving assembly comprises a motor, a helical gear, a transmission gear, and an output gear; the said motor is provided on one side of the said housing, the said helical gear is provided on one side of the said motor and connected with the output end of the said motor in a transmission way, the said transmission gear is provided on one side of the said helical gear and connected with the said helical gear in a transmission way, the said output gear is provided on one side of the said transmission gear and connected with the said transmission gear in a transmission way, the end of the said transmission shaft passing through the top of the said housing is located in the said transmission gear, when rotating, the said transmission gear drives the said transmission shaft to rotate, and the said transmission shaft can slide along the axial direction of the output gear in the output gear.

In a preferred embodiment, the said housing comprises an upper housing and a lower housing, the said upper housing is connected with the said lower housing in a fixed way, the said driving assembly is provided in the said lower housing, there is a concave hole on the said lower housing used for placement of the said output gear, and there is a plurality of vent holes on the said lower housing corresponding to the said motor.

In a preferred embodiment, there is a fixed block at the end of the said transmission shaft passing through the top of the said housing, the said fixed block is fitted with the said output gear, and said transmission shaft can rotate with the output gear through the said fixed block and/or slide along the axial direction of the said output gear in the said output gear, one end of the said reset spring is butted with the said fixed block, and the other end thereof is butted with the inner wall of the said upper housing.

In a preferred embodiment, there is a horizontally protruding stop block on the side wall of the said jacking bracket.

In a preferred embodiment, there is a vertical limit slot on the side wall of the said jacking support, the said limit slot is fitted with the said stop block, and the said stop block is located in the said limit slot.

In a preferred embodiment, the said jacking part is an air bag, the said air bag is circular, and there is an inflation inlet on the bottom of the said air bag.

The beneficial effects of the present utility model: Based on the present utility model, it is possible to extend the massage head by providing the jacking part, so as to meet the usage requirements of different people.

Furthermore, by providing the sliding transmission shaft and the reset spring, the transmission shaft will be extended and retracted synchronously when the massage head is extended and retracted, so as to achieve the complete retraction of the massage head as a whole without affecting the other ways to use the massager, and improve the usage experience of the user.

### DESCRIPTION OF APPENDED DRAWINGS

FIG. 1 is the schematic diagram for structure of the present utility model;

FIG. 2 is the exploded view of the present utility model;

FIG. 3 is the cross-section view of the present utility model;

FIG. 4 is the diagram of the present utility model in extending state.

Where:
10. Massage device; 11. Housing; 111. Upper housing; 112. Lower housing; 113. Concave hole; 114. Vent hole; 12. Driving assembly; 121. Motor; 122. Helical gear; 123. Transmission gear, 124. Output gear, 13. Massage head; 131. Transmission shaft; 132. Fixed block; 133. Reset spring; 14. Jacking support; 141. Limit slot; 15. Jacking part; 151. Inflation inlet; 16. Jacking bracket; 161. Stop block.

### DETAILED DESCRIPTION OF EMBODIMENTS

In order to make the above purposes, features and advantages of the present utility model more distinct and understandable, the specific embodiments of the present utility model are described in detail below in combination with the appended drawings. A great number of concrete details are set forth in the following description to facilitate the full understanding of the present utility model. However, the present utility model can be implemented in many other ways different from those described herein, and the persons skilled in the art may make similar improvements without contravening the connotation of the present utility model; therefore, the present utility model is not limited by the specific embodiments disclosed below.

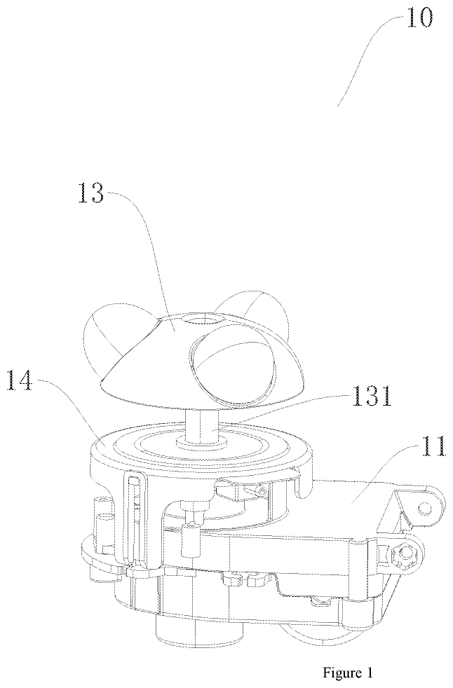

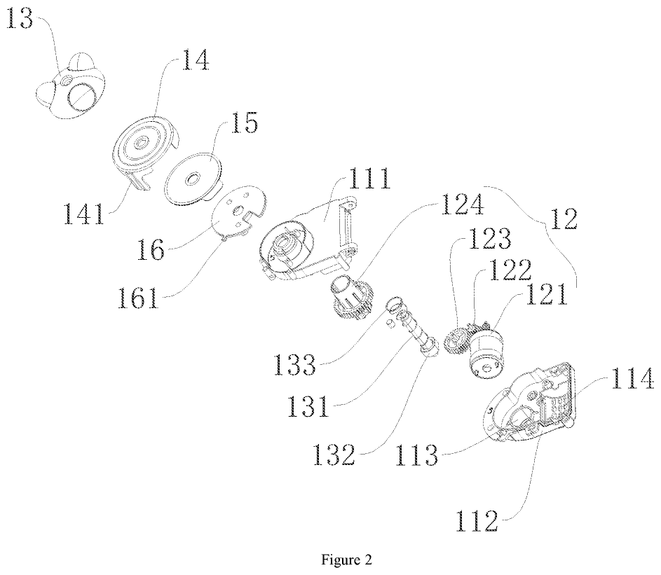

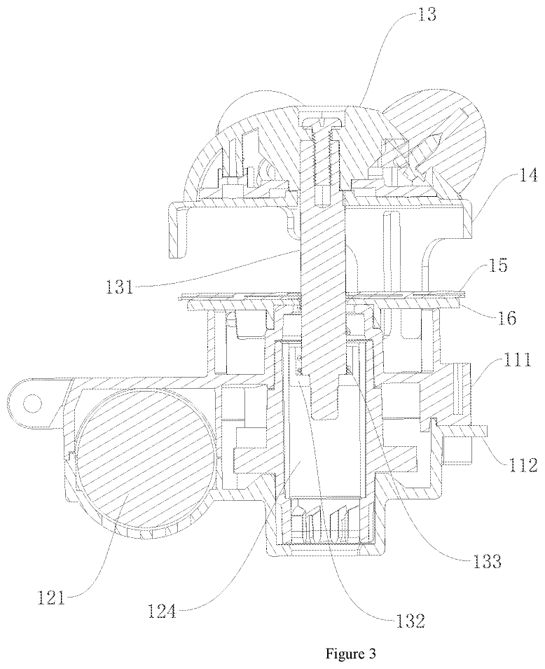

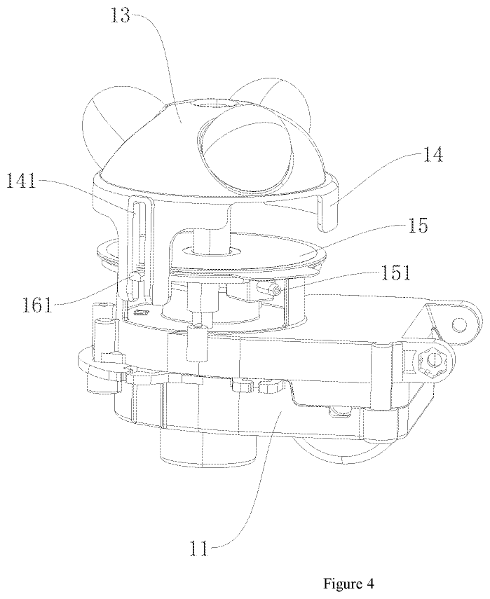

As shown in FIG. 1-FIG. 4, the present utility model provides a massager with a retractable massage head, comprising a massage body adaptable to human neck and at least two massage devices 10, the said massage devices 10 are provided on the side of the said massage body adjacent to the human body, and each said massage device 10 comprises a housing 11, in which there is a driving assembly 12. On top of the said housing 11, there is the massage head 13 connected with the said driving assembly 12 in a transmission way; between the said housing 11 and the said massage head 13, there are jacking support 14, jacking part 15, and jacking bracket 16 from top to bottom. The said jacking bracket 16 is connected with the top of the said housing 11 in a fixed way, the said jacking part 15 is located on the said jacking bracket 14, the said jacking support 14 is connected with the bottom of the said massage head 13, the bottom of the said massage head 13 is connected with a transmission shaft in a fixed way, the end of the said transmission shaft 131 away from the said massage head 13 passes through the said jacking support 14, the said supporting part 15, the said supporting bracket 16, and the top of the said housing 11 and is connected with the said driving assembly 12, and there is a reset spring 133 at the end of the said transmission shaft 131 connected with the said driving assembly 12. Specifically, the massage head 13 is driven by the driving assembly 12; when the driving assembly 12 is running, the driving assembly 12 drives the transmission shaft 131 to run synchronously, the transmission shaft 131 drives the massage head 13 to rotate so as to massage the human neck. The jacking support 14 and the jacking part 15 are fixed between the massage head 13 and the housing 11 through the transmission shaft 131; and since the transmission shaft 131 passes through the jacking support 14, the jacking support 14 can slide along the transmission shaft 131; when the jacking part 15 is working, the jacking part 15 jacks up the jacking support 14, the jacking support 14 jacks up the massage head 13 under the acting force of the jacking part 15, so that the massage head 13 protrudes from the massage body, so as to facilitate the adaptation to the people with different neck sizes or to meet the requirements of the people for high compressive force. The reset spring 133 is used to restore the massage head 13 to its original position. When the massage head 13 is pushed out under the acting force of the jacking part 15, the transmission shaft 131 will be pulled out and moved by the massage head 13 because one end of the transmission shaft 131 is connected with the massage head 13 in a fixed way. At this point, the pull-out of the transmission shaft 131 will compress the reset spring 133 located on it, causing it to produce a restoring force. When the jacking part 15 stops working, the massage head 13 will lose the acting force from the jacking part 15, and then act on the transmission shaft 131 under the restoring force of the reset spring 133 to cause the transmission shaft 131 to return and drive the massage head 13 to return, so as to achieve the retraction of the massage head 13 as a whole, which is convenient to improve the usage experience of the massager in other ways.

Further, in the present embodiment, the said driving assembly 12 comprises a motor 121, a helical gear 122, a transmission gear 123, and an output gear 124; the said motor 121 is provide on one side of the said housing 11, the said helical gear 122 is provided on one side of the motor 121 and connected with the output end of the said motor 121 in a transmission way, the said transmission gear 123 is provided on one side of the said helical gear 122 and connected with the said helical gear 122 in a transmission way, the said output gear 124 is provided on one side of the said transmission gear 123 and connected with the said transmission gear 123 in a transmission way, and the end of the said transmission shaft passing through the top of the said housing 11 is located in the said transmission gear 123; when rotating, the said transmission gear 124 drives the said transmission shaft 131 to rotate, and the said transmission shaft 131 can slide along the axial direction of the said output gear 124 in the output gear 124. Specially, both the helical gear 122 and the transmission gear 123 are duplicate gears. When working, the motor 121 drives the helical gear 122 engaged with it for transmission to rotate, the helical gear 122 drives the transmission gear 123 engaged with it for transmission to rotate, the transmission gear 123 drives the output gear 124 engaged with it for transmission to rotate, the output gear 124 drives the transmission shaft in it to rotate, so as to enable the transmission shaft to drive the massage head 13 to rotate simultaneously, and reduce the space requirement of the housing 11 through the transmission fitting between the helical gear 122 and the motor 121, so as to reduce the volume of the housing 11.

Further, the said housing 11 comprises the upper housing 111 and the lower housing 111, the said upper housing 111 is connected with the said lower housing 112 in a fixed way, the said driving assembly 12 is provided in the said lower housing 112, there is a concave hole 113 on the said lower housing 112 used for placement of the said output gear 124, and there is a plurality of vent holes 114 on the said lower housing 112 corresponding to the said motor 121. Specially, since the output gear 124 is a hollow circular column, in order to limit the translation of the output gear 124 but not to limit the rotation of the output gear 124, in the present embodiment, a sunken concave hole 113 is provided in the lower housing 112, so that the bottom of the output gear 124 can be inserted into the concave hole 113, and the translation of the output gear 124 is limited through the concave hole 113, while the rotation of the output gear 124 is not limited, so that the output gear 124 can rotate driven by the transmission gear 123, and then the transmission shaft 131 is driven to rotate; there is a plurality of vent holes on the lower housing 112 corresponding to the motor 121, which are used to dissipate immediately the heat generated by the motor 121 during operation, so as to avoid overheating of the motor 121, affecting the operation.

Further, in the present embodiment, there is a fixed block 132 at the end of the said transmission shaft 131 passing through the top of the said housing 11, the said fixed block 132 is fitted with the said output gear 124, and said transmission shaft 131 can rotate with the output gear 124 through the said fixed block 132 and/or slide along the axial direction of the said output gear 124 in the said output gear 124, one end of the said reset spring 133 is butted with the said fixed block 132, and the other end thereof is butted with the inner wall of the said upper housing 111. Specifically, in order to enable the transmission shaft 131 to move along the axial direction of the output gear 124 in the output gear 124, and to rotate with the rotation of the output gear 124; at the end of the transmission shaft 131 located in the housing 11, there is a fixed block, which shall be polygonal but not circular, and the inside of the output gear 124 shall be fitted with the fixed block 132, so that the fixed block 132 can slide along the axial direction of the output gear 124 in the output gear 124 while rotating with the rotation of the output gear 124, so as to avoid the conflict between them, resulting in the situation of only rotation or only sliding; furthermore, by providing the fixed block 132, the reset spring 133 can be extruded and compressed by the fixed block 132 when the transmission shaft 131 is pulled out; at the same time, when releasing the restoring force, the reset spring 133 takes the fixed block 132 as the point of force application, so that the transmission 131 is driven to retract to the original position.

Further, in the present embodiment, there is a horizontal protruding guide block on the side wall of the said jacking bracket, there is a vertical guide slot on the side wall of the said jacking support 14, the said guide slot is fitted with the said guide block, and the said guide block is located in the said guide slot. Specially, in order to prevent the jacking support 14 from rotating synchronously when the transmission 131 is rotating, there is a horizontally protruding stop block 161 on the side wall of the jacking bracket 16, and there is a limit slot on the side wall of the jacking support 14; the limit slot is matched with the stop block 161, and the limit block 161 is located in the limit slot 141; because the jacking bracket 16 is connected with the upper housing 11I in a fixed way by screws and other fasteners, the jacking bracket 16 will not rotate, and the jacking support 14 will not rotate with the rotation of the transmission shaft 131 due to the limitation on the fitting between the limit slot 141 and the stop block 161, so as to prevent the scrapping against the jacking part 15.

Further, in the present embodiment, the said jacking part 15 is an air bag, the said air bag is circular, and there is an inflation inlet 151 on the bottom of the said air bag. Specifically, in the present embodiment, the jacking part 15 is an air bag; the air bag is circular, that is, there is a hole in the middle of the air bag, through which the transmission shaft 131 will pass without affecting the air bag; on the bottom of the air bag, there is an inflation inlet 151, the air bag is connected through the inflation inlet 151 with the external inflation device for inflation; when the air bag is inflated and expanded, jack up the jacking support 14, the jacking support 14 jacks up the massage head 13, the massage head 14 drives the transmission shaft 131, the transmission shaft 131 extrudes the reset spring 133 through the fixed block 132 so as to compress the reset spring 133; if the massage head 13 is not required to extend, the air bag may be deflated through the air hole, so that the air bag will become flat, the jacking support 14 will lose the jacking force from the air bag; furthermore, after losing the extrusion force, the reset spring 133 will release the restoring force acting on the fixed block 132 to retract the transmission shaft 131, so as to drive the massage head 13 to retract, and the massage head 13 will extrude to retract the jacking support 14, so as to achieve the retraction of the massage head 13 as a whole.

In summary, by providing the jacking part 15, the present utility model enables the massage head to extend, so as to meet the usage requirements of different people. Furthermore, by providing the sliding transmission shaft 131 and the reset spring 133, the transmission shaft 131 will be extended and retracted synchronously when the massage head 13 is extended and retracted, so as to achieve the complete retraction of the massage head 13 as a whole without affecting the other ways to use the massager, and improve the usage experience of the user.

The present utility model is not limited solely to what is described in the specification and the embodiments, so that it is easy for the persons skilled in the art to realize the additional advantages and modifications; therefore, without deviating from the spirit and scope of the general concepts defined by the Claims and the scope of equivalence, the present utility model is not limited to specific details, representative equipment, and illustrative examples as shown and described here.

1. A kind of massager with a retractable massage head, comprising a massage body adaptable to the human neck and at least two massage devices; the said massage devices are provided on the side of the said massage body adjacent to the human body and characterized by that each said massage device comprises a housing, in which there is a driving assembly. On top of the said housing, there is the massage head connected with the said driving assembly in a transmission way; between the said housing and the said massage head, there are jacking support, jacking part, and jacking bracket from top to bottom. The said jacking bracket is connected with the top of the said housing in a fixed way, the said jacking part is located on the said jacking bracket, the said jacking support is connected with the bottom of the said massage head, the bottom of the said massage head is connected with a transmission shaft in a fixed way, the end of the said transmission shaft away from the said massage head passes through the said jacking support, the said supporting part, the said supporting bracket, and the top of the said housing and is connected with the said driving assembly, and there is a reset spring at the end of the said transmission shaft connected with the said driving assembly.

2. A massager with a retractable massage head as described in claim 1 is characterized by that the said driving assembly comprises a motor, a helical gear, a transmission gear and an output gear; the said motor is provided on one side of the said housing, the said helical gear is provided on one side of the said motor and connected with the output end of the said motor in a transmission way, the said transmission gear is provided on one side of the said helical gear and connected with the said helical gear in a transmission way, the said output gear is provided on one side of the said transmission gear and connected with the said transmission gear in a transmission way, the end of the said transmission shaft passing through the top of the said housing is located in the said transmission gear, when rotating, the said transmission gear drives the said transmission shaft to rotate, and the said transmission shaft can slide along the axial direction of the output gear in the output gear.

3. A massager with a retractable massage head as described in claim 2 is characterized by that the said housing comprises an upper housing and a lower housing, the said upper housing is connected with the said lower housing in a fixed way, the said driving assembly is provided in the said lower housing, there is a concave hole on the said lower housing used for placement of the said output gear, and there is a plurality of vent holes on the said lower housing corresponding to the said motor.

4. A massager with a retractable massage head as described in claim 3 is characterized by that there is a fixed block at the end of the said transmission shaft passing through the top of the said housing, the said fixed block is fitted with the said output gear, and said transmission shaft can rotate with the output gear through the said fixed block and/or slide along the axial direction of the said output gear in the said output gear, one end of the said reset spring is butted with the said fixed block, and the other end thereof is butted with the inner wall of the said upper housing.

5. A massager with a retractable massage head as described in claim 1 is characterized by that there is a horizontally protruding stop block on the side wall of the said jacking bracket.

6. A massager with a retractable massage head as described in claim 5 is characterized by that there is a vertical limit slot on the side wall of the said jacking support, the said limit slot is fitted with the said stop block, and the said stop block is located in the said limit slot.

7. A massager with a retractable massage head as described in claim 5 is characterized by that the said jacking part is an air bag, the said air bag is circular, and there is an inflation inlet on the bottom of the said air bag.
